(19) United States
(12) Patent Application Publication
(10) Pub. No.: US 2026/0206072 A1
(43) Pub. Date: Jul. 16, 2026

(54) METHODS, APPARATUSES AND SYSTEMS FOR REGISTRATION AND DISCOVERY OF DEVICE EDGE SERVICES

(71) Applicant: InterDigital Patent Holdings, Inc., Wilmington, DE (US)

(72) Inventors: Kevin Di Lallo, Laval (CA); Debashish Purkayastha, Eagleville, PA (US); Robert Gazda, Spring City, PA (US); Michel Roy, Candiac (CA); Michael Starsinic, Newtown, PA (US); Antonio de la Oliva, Madrid (ES)

(21) Appl. No.: 19/021,968

(22) Filed: Jan. 15, 2025

(51) Int. Cl. H04W 76/10

(52) U.S. Cl. CPC H04W 76/10

(57) ABSTRACT

In an embodiment, a method, implemented in a WTRU, comprises transmitting, to a network, a first message comprising first information indicating a first request for configuring a connectivity with a device edge application server (DEAS); receiving, from the network, a second message comprising second information indicating DEAS connectivity configuration information; performing a DEAS connectivity configuration based on the received second message; transmitting, to the network, a third message comprising third information indicating a second request to register the DEAS; and receiving, from the network, a fourth message comprising fourth information indicating that DEAS is registered.

### FIELD OF THE INVENTION

The present disclosure is generally directed to methods, architecture apparatuses and systems for registration and discovery of device edge services. More particularly, the present disclosure relates to methods to enable an application client (AC) and an application server (AS) on a wireless transmit/receive unit (WTRU) or an application server (AS) in the network to discover and establish connectivity with an application server running on a (e.g., another or the same) WTRU (e.g., a device edge application server (DEAS)).

### BACKGROUND

New industrial internet of things (IoT) applications may require secure and low latency access to compute and storage resources to meet stringent application demands. Edge computing technologies may be used to reduce latency by enabling the deployment of applications within the operator network. Edge computing may bring the network storage and compute closer to the users (e.g., application clients) that require it.

Current edge computing capabilities in the 3GPP system are limited to edge application deployments at the telco edge (e.g., applications within an edge data network (EDN) that is accessible via a user plane function (UPF)). However, some applications may have latency and security requirements that cannot be met by existing edge computing capabilities. To meet such stringent requirements, it is expected that next generation systems will enable the deployment of compute and storage at a device edge (e.g., on a WTRU) so that application clients (e.g., running on the same WTRU, on another WTRU, on another device, or in the network) can discover and establish connectivity with application servers running on a (e.g., another or the same) WTRU with device edge capabilities.

There is a need to enable and manage compute and storage deployments at a device edge, and to enable the discovery of applications and services deployed at the Device Edge by application clients.

### SUMMARY

In an embodiment, a method, implemented in a wireless transmit/receive unit (WTRU), may comprise a step of transmitting, to a network, a first message comprising first information indicating a first request for determining a connectivity configuration with a device edge application server (DEAS). The method may comprise a step of receiving, from the network, a second message comprising second information indicating DEAS connectivity configuration information. The method may comprise a step of performing a configuration of a connectivity of the WTRU based on the received second message. The method may comprise a step of transmitting, to the network, a third message comprising third information indicating a second request to register the DEAS; and a step of receiving, from the network, a fourth message comprising fourth information indicating that DEAS is registered. The method may comprise a step of forwarding, to the DEAS, the fourth message.

The first information may further indicate any of: WTRU information, WTRU connectivity configuration information, and a profile of the DEAS, wherein the DEAS profile includes any of DEAS access permissions, and WTRU configuration requirements and preferences. The DEAS connectivity configuration information may comprise a WTRU connectivity configuration information and DEAS connection information, wherein the DEAS connection information includes any of data network information, ProSe discovery filters, personal internet of things (IoT) network information, and DEAS endpoint information.

The WTRU may comprise a device edge enabler function (DEEF) providing device edge enablement services to the WTRU. Performing the DEAS connectivity configuration may be triggered by the DEEF. The third information may further indicate any of: a profile of the DEAS, and DEAS connection information based on the received second message. The fourth information may further indicate a registration identifier of the DEAS.

The method may further comprise a step of receiving, from the DEAS, an initial request message to register the DEAS; and wherein transmitting the first message is based on receiving the initial request message. The initial request message may comprise fifth information indicating a DEAS profile including any of DEAS access permissions, and WTRU configuration requirements and preferences. The initial request message may comprise sixth information indicating DEAS connection information including any of data network information, ProSe discovery filters, personal internet of things (IoT) network information, and DEAS endpoint information.

In an embodiment, a wireless transmit/receive unit (WTRU) comprising a processor, a transmitter, a receiver and a memory, may be configured to transmit, to a network, a first message comprising first information indicating a first request for determining a connectivity configuration with a device edge application server (DEAS). The WTRU may be further configured to receive, from the network, a second message comprising second information indicating DEAS connectivity configuration information. The WTRU may be further configured to perform a configuration of a connectivity of the WTRU based on the received second message. The WTRU may be further configured to transmit, to the network, a third message comprising third information indicating a second request to register the DEAS; and to receive, from the network, a fourth message comprising fourth information indicating that DEAS is registered.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example of a block diagram illustrating an architecture for enabling edge applications, according to an embodiment;

FIG. 3 is an example of a block diagram illustrating an example of a device edge enabler function (DEEF), device edge configuration function (DECF) and device edge registry function (DERF) deployment as edge enablement architecture, according to an embodiment;

FIG. 4 is an example of a signaling diagram illustrating an example of a device edge application server (DEAS) registration and configuration, according to an embodiment;

FIG. 5 is an example of a signaling diagram illustrating an example of WTRU-requested DEAS discover, according to an embodiment;

FIG. 6 is a signaling diagram illustrating an example of network-requested DEAS discover, according to an embodiment; and

FIG. 7 is an example of a flow chart illustrating an example of a method of WTRU-requested DEAS registration, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’ may imply ‘A and/or B’.

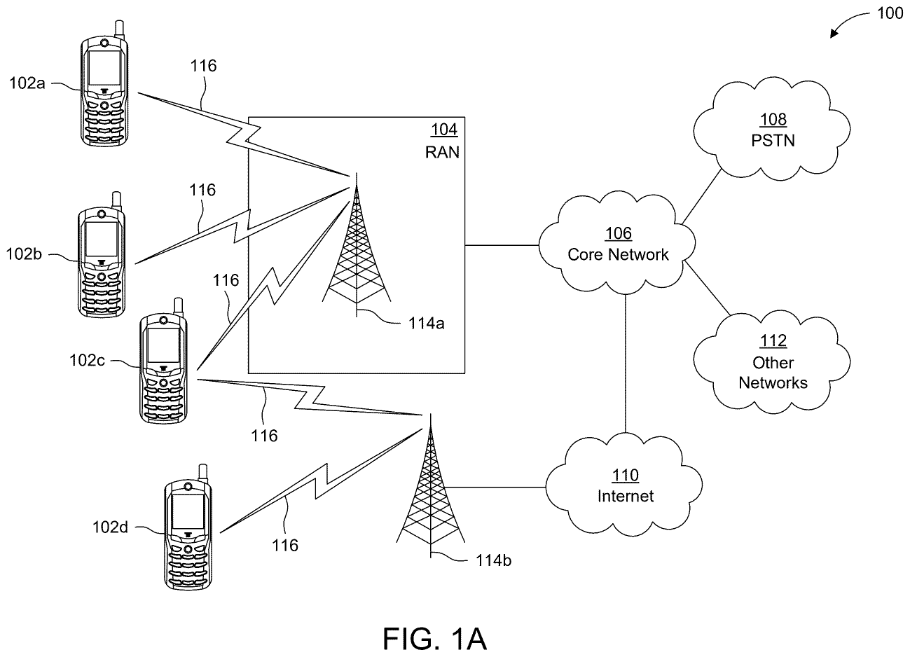

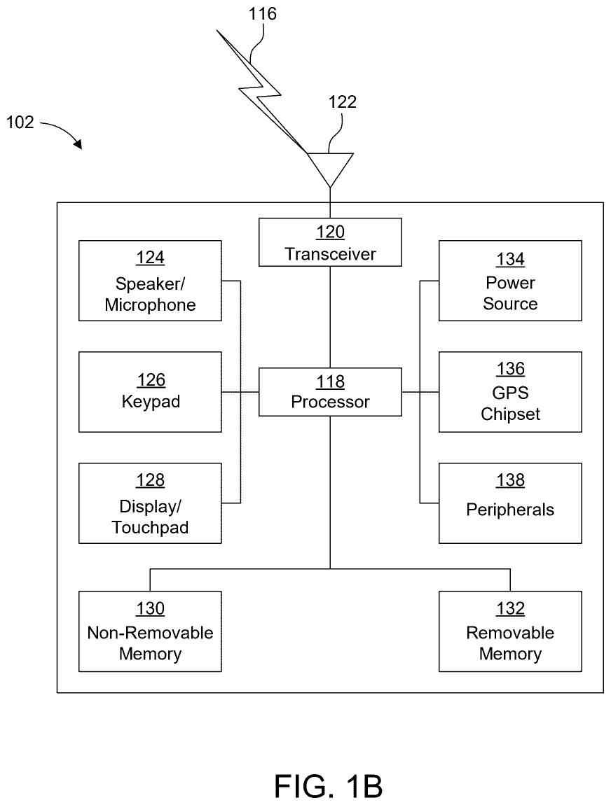

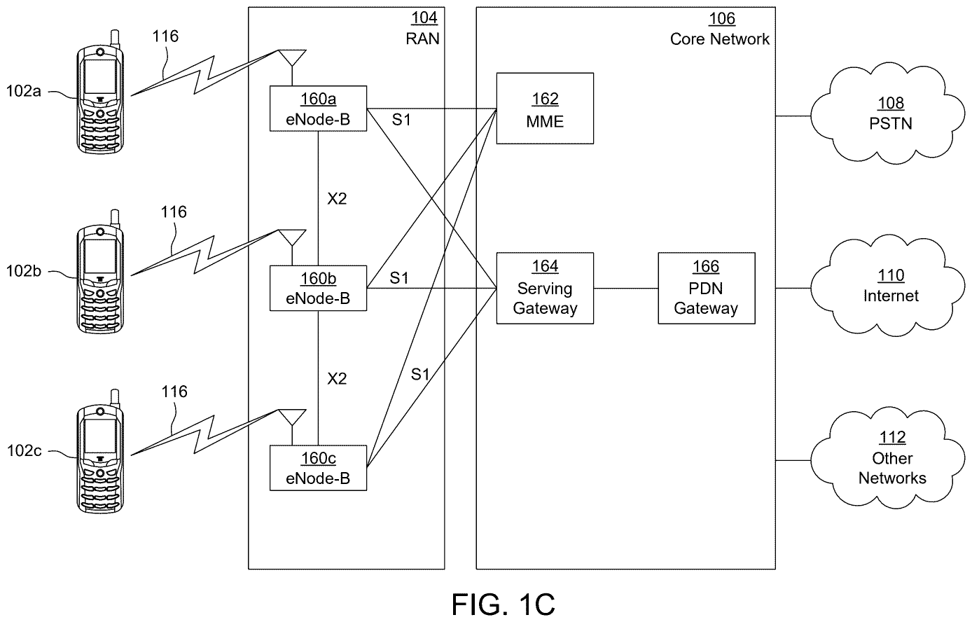

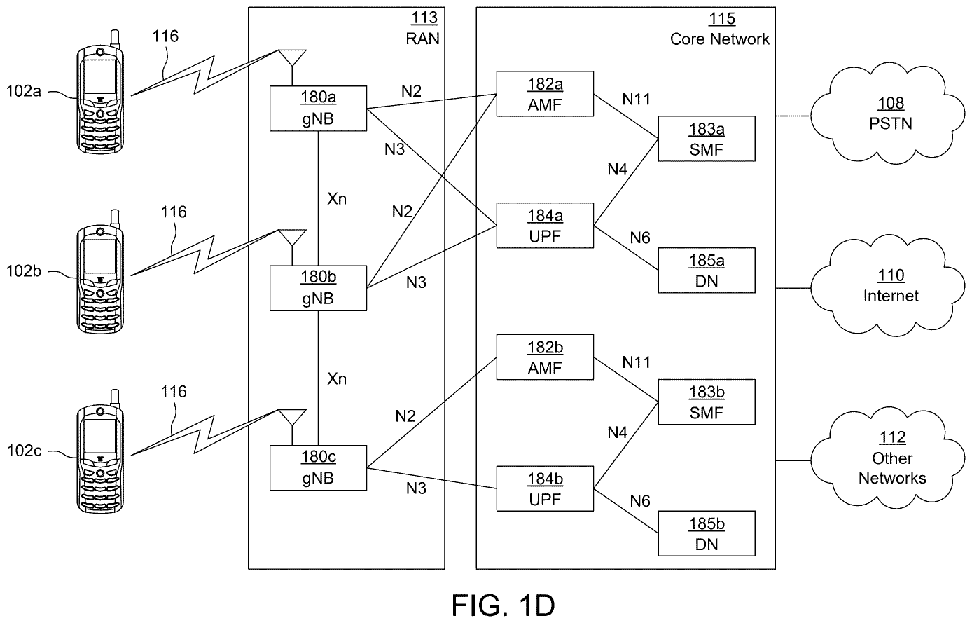

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one access and mobility management function (AMF) 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

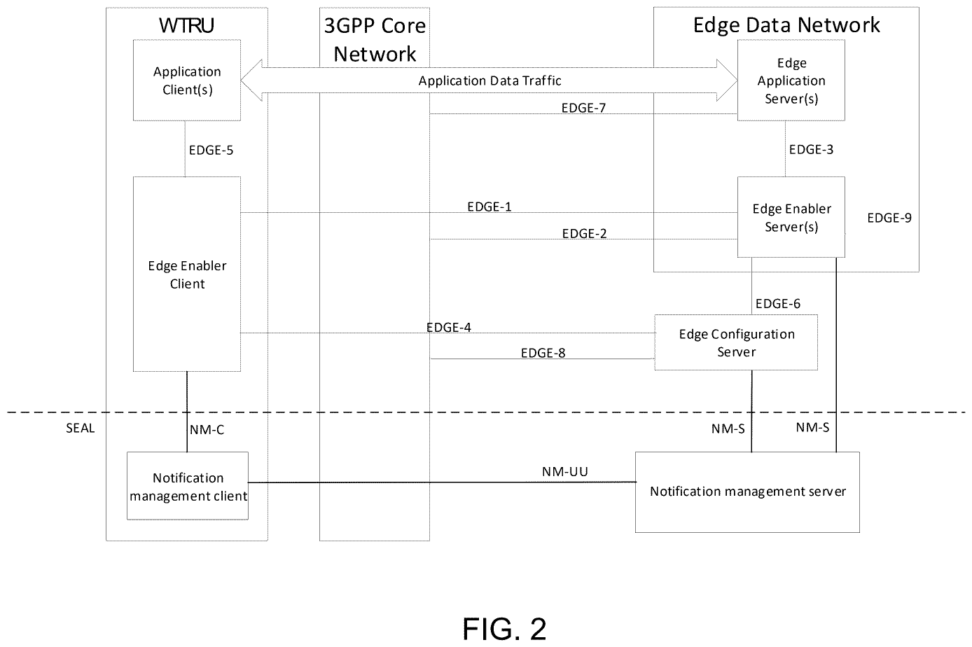

Referring to FIG. 2, a (e.g., high level) architecture for enabling edge application is shown. An application client (AC) may be an application residing on a WTRU that may communicate with an edge application server (EAS). The WTRU may use several AC concurrently. An EAS may be an application server resident in an edge data network (EDN). Typically, it may be a software server executing on generic hardware located at the edge and providing a service to the AC. There can be multiple EAS instances per EDN. Each EDN may contain a different set of EAS instances of different types (e.g., different edge application server identification (EASID)). An EAS may serve one or more AC instances that may reside on different WTRUs. An edge enabler client (EEC) may provide edge support to the AC instances on the WTRU. There can be one or more EEC per WTRU. Each AC may use only one EEC. An edge enabler server (EES) may provide supporting functions needed by EAS and EEC. There can be one or more EES instance per EDN (or per data network name (DNN)). There can be multiple EDN instances in the network. An edge configuration server (ECS) may provide supporting functions for an EEC or EES to discover EES instances providing (e.g., certain) EAS. There can be one or more ECS for the network. A notification management client (NMC) may provide supporting functions for an EEC to create a notification channel between a NMC and a notification management server (NMS) to receive notifications from the ECS or EES. Each EEC may use only one NMC. A notification management server (NMS) may provide supporting functions for an ECS or EES to send notifications to an EEC via a notification channel created between the NMC and the NMS. There can be one or more NMS for the network.

A device edge may be viewed as an extension to a telco edge and cloud, enabling edge services on mobile and resource-limited devices (e.g., WTRUs). A device edge WTRU may refer to a WTRU with device edge capabilities where device edge services may be deployed.

There may be different scenarios where it may be advantageous to enable a reduced capability multi-access edge computing (MEC) platform (e.g., constrained MEC (CMEC)) for deployment on constrained devices, thus allowing MEC applications to be instantiated on these constrained devices, including but not limited to the following: (i) vehicular scenarios, where a constrained MEC host (CMH), embedded in a vehicle, might run applications for the vehicle (like onboard processing of sensed data), other neighboring vehicles (e.g., in platooning situations) or for the edge network (for safety and traffic efficiency applications); (ii) industry 4.0 scenarios, where mobile robots or robot arms, mobile cameras may also host MEC applications to minimize the latency required by certain use cases; (iii) XR gaming scenarios, where cloud-based gaming applications using AR/VR might need ultra-low latencies and/or extended computational capabilities, which can be provided by CMHs in the same household.

5G systems may support a discovery of edge services via domain name system (DNS) based core network procedures and/or via service enablement layer procedures. DNS based core network procedures may allow an application client on a WTRU to discover and direct traffic to a requested edge service instance deployed in an EDN. Service enablement layer services (e.g., as defined in the edge enabler architecture) may provide an application programing interface (API) for a WTRU to discover edge application servers deployed in an EDN. In both cases, edge applications and services may be deployed at the telco edge (e.g., in an EDN).

Next generation systems may be expected to enable the deployment of edge applications and services at a device edge (e.g., on a WTRU). System enhancements may be desired to enable the discovery of edge applications and services deployed at the device edge. The system enhancements should allow an application server running on a WTRU to expose services to local and/or remote applications (e.g., AC, AS), and should allow application clients (e.g., running on the same WTRU, on another WTRU, another device, or in the network) to discover and establish connectivity with application servers running on a (e.g., another or the same) WTRU.

A local application refers to an application (e.g., AC, AS) that runs in a terminal equipment (TE) part of a device edge WTRU or that runs on another WTRU that is within device-to-device (D2D) range (e.g., Wi-Fi, Bluetooth or PC5 range) of the requested device edge WTRU. A remote application may refer to an application (e.g., AC, AS) that runs on a WTRU that is out of D2D range (e.g., Wi-Fi, Bluetooth or PC5 range) of the requested device edge WTRU, or that runs in the network (e.g., EDN, cloud).

The various embodiments below may propose enhancements to enable an application client (AC) on a WTRU or an application server (AS) in the network to discover and establish connectivity with an application server running on a (e.g., another or the same) WTRU (e.g., a device edge application server (DEAS)). A device edge enabler function (DEEF), a device edge configuration function (DECF) and a device edge registry function (DERF), functional entities may be proposed as enhancements to the current 3GPP system, to manage DEAS registration, configuration and discovery.

When requested by a DEAS, an enabler function (e.g., a DEEF) on a WTRU may configure DEAS connectivity to make the DEAS reachable to authorized application clients and servers. The DEEF may determine or obtain DEAS connectivity configuration information directly from the requesting DEAS or by communicating with a DECF in the network. The DEEF may register the DEAS with the DERF to make the DEAS discoverable to authorized application clients and servers. The DEEF may include the DEAS connectivity information in the request for DEAS registration.

When requested by an AC, an enabler function (e.g., a DEEF) on a WTRU may discover DEAS instances of interest to the requesting AC. When requested by an AS, an enabler function (e.g., a DEEF) in a network may discover DEAS instances of interest to the requesting AS. The DEEF may obtain a list of DEAS instances of interest by providing requestor information and discovery filters to a DERF. The DERF may identify DEAS instances that match the discovery filters and that are discoverable by the requestor. The DERF may include DEAS instance connectivity information in the response to the DEEF. The DEEF may provide the list of discovered DEAS instances and DEAS connectivity information to the requestor. The requestor may use the DEAS connectivity information to connect to and avail the services of the selected DEAS instance(s).

In addition to the above definition of common terminology, according to the below various embodiments, an application client (AC) may further be an application that may reside on a WTRU and that may communicate with an AS in a DN or a DEAS on a WTRU. A WTRU may use several AC concurrently. An application server (AS) may be an application server that may reside in a DN. An AS may be a software server executing on generic hardware and providing a service to an AC or to another AS. An AS may interact with one or more AC instances that may reside on different WTRUs. An AS may interact with one or more AS instances that may reside in different DNs. A device edge application server (DEAS) may be an AS that resides at the device edge (e.g., on a WTRU or in a device edge DN). A DEAS may serve one or more AC instances that may reside on different WTRUs. A DEAS may serve one or more AS instances that may reside in different DNs. An enabler client (EC) may be a service enabler that resides on a WTRU, that may communicate with an enabler server(ES) and that may provide client-side functionalities to ACs for a specific enablement service. An ES may be a service enabler that resides in a DN. An ES may provide server-side functionalities to ASs for a specific enablement service. An ES may serve one or more EC instances that may reside on different WTRUs. Requestor information may be information that may characterize a requestor. Requestor information may include any of (i) a user identifier (e.g., unique ID), (ii) AC or AS identifier (e.g., unique ID), and (iii) AC or AS type. WTRU information may be information that may characterize a WTRU. WTRU information may include any of: (i) a WTRU identifier (e.g., SUPI, GPSI, phone number), (ii) a WTRU state, (iii) a WTRU location (e.g., a geographical or topological location), (iv) a WTRU path (e.g., planned WTRU location over time), and (v) WTRU capabilities. The WTRU capabilities may include any of: (i) supported radio access technologies (RAT) (e.g., LTE, 5G NR, NR-PC 5, Wi-Fi, etc.), (ii) connectivity capabilities (e.g., 5G VN, ProSe, PIN), (iii) processing capabilities (e.g., CPU, GPU), and (iv) artificial intelligence/machine learning (AI/ML) processing capabilities. WTRU connectivity configuration information may be information that may characterize the connectivity configuration parameters of a WTRU. WTRU connectivity configuration information may include any of: (i) data network information (e.g., a DNN for an EDN, slice or virtual network), (ii) a ProSe policy and proximity services (ProSe) parameters (e.g., ProSe application ID, ProSe application code), and (iii) personal IoT network (PIN) configuration information (e.g., PIN ID, PIN server ID, PIN client ID). A DEAS profile may contain information that may characterize a DEAS. A DEAS profile may include any information from the EAS profile. DEAS information may also include any of: (i) a DEAS coverage area (e.g., a geographical or topological area where service is offered), (ii) DEAS access permissions (e.g., local and/or remote user access permissions), (iii) WTRU connectivity configuration requirements (e.g., DEAS provided connectivity configuration, WTRU determined connectivity configuration, network provided connectivity configuration), and (iv) WTRU connectivity preferences (e.g., 5G VN for remote DEAS access and PIN or ProSe for local DEAS access). DEAS connection information may be information that may characterize the connectivity parameters required to connect to a DEAS. DEAS connection information may include any of: (i) data network information (e.g., a DNN for an EDN, slice or virtual network), (ii) ProSe discovery filters (e.g., ProSe Application ID, ProSe application code), (iii) PIN information (e.g., PIN ID, PIN server ID, PIN client ID), (iv) external group ID (e.g., to identify a virtual network group), and (v) DEAS endpoint information (e.g., IP address, uniform resource identifier (URI), fully qualified domain name (FQDN)). DEAS discovery filters may contain information about the DEAS characteristics that should be used to identify matching DEAS instances. DEAS discovery filters may include any information from the DEAS profile. DEAS discovery filters may include WTRU connectivity preferences (e.g., 5G VN for remote DEAS access and PIN or ProSe for local DEAS access) and/or a DEAS area of interest (e.g., a geographical or topological area where service is available to local and/or remote users).

Current edge computing capabilities may not be sufficient to meet the latency and security requirements of new industrial IoT applications. Current 5G systems may be limited to edge application deployments at the telco edge (e.g., applications within an EDN that is accessible via a UPF). It is expected that next generation systems will enable the deployment of compute and storage at the device edge (e.g., on a WTRU). The below various embodiments may solve the problem that current 3GPP systems do not support the management operations required for deploying, configuring, and discovering applications at the device edge. System enhancements may be proposed to allow an application server running on a WTRU (e.g., a DEAS) to expose services to local and/or remote applications (e.g., AC, AS), and to allow application clients (e.g., running on the same WTRU, on another WTRU, or in the network) to discover and establish connectivity with application servers running on a (e.g., another or the same) WTRU.

The various embodiments below may propose new service enablement layer functions (e.g., a device edge enabler function (DEEF), a device edge configuration function (DECF) and a device edge registry function (DERF)), to manage DEAS registration, configuration and discovery. The various embodiments below may propose enhancements to the 3GPP service enablement layer and/or 5G core network to enable discovery, management, and configuration of connectivity for device edge computing services (e.g., DEAS instances). These enhancements may be defined in a DEEF, a DECF, and a DERF described herein.

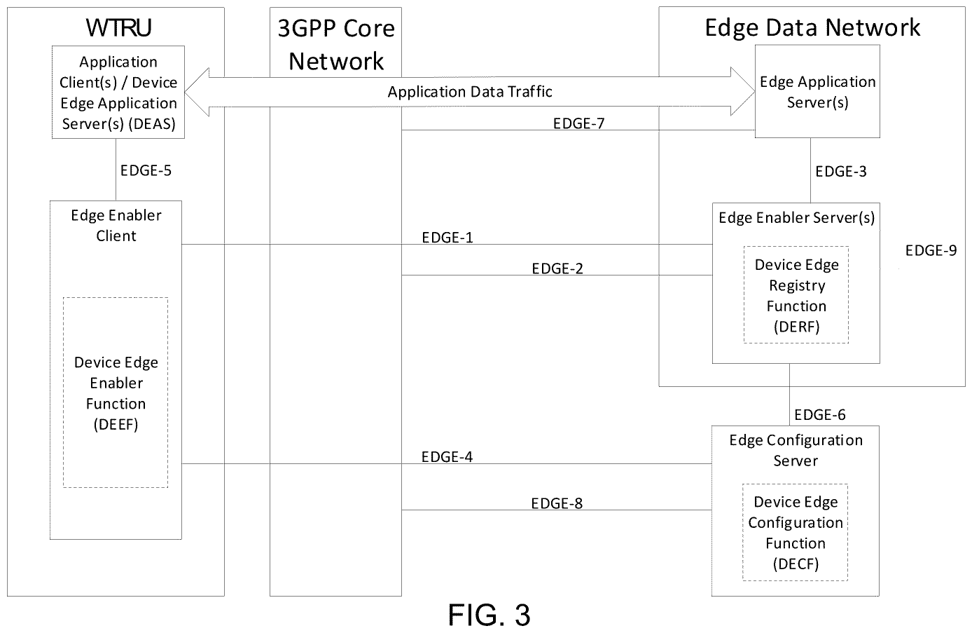

Referring to FIG. 3, an example of a deployment of the DEEF, DECF and DERF as service enablement layer enhancements to the edge enablement architecture is shown. In this deployment, the EEC may perform functions of a DEEF, the ECS may perform functions of a DECF, and the EES may perform functions of a DERF. A DEAS on a WTRU may use the services of the DEEF to expose device edge services to application clients and servers on other WTRUs or in the network. An application client on a WTRU or an application server in the network may use the services of the DEEF, DERF and DECF to discover and connect to a registered DEAS.

In a mobile network, a DEEF may provide device edge enablement services to applications (e.g., AC, DEAS) on a WTRU and to applications (e.g., AS) in a network. Device edge enablement services may include procedures for registering and discovering a DEAS.

The DEEF may offer device edge enablement services via an application programming interface (API). The DEEF functionality may be implemented as a standalone application function (AF) or as a network function (NF). The DEEF functionality may be combined with an existing AF or NF, and the API may be offered as an extension of an existing API and the API may be based on a service-based interface.

The DEEF services may be offered using a communication protocol. For example, the Hyper Text Transfer Protocol (HTTP) for 5G systems may provide access to the capabilities of the DEEF services.

The DEEF may be located on a WTRU (e.g., terminal component) or in a network (e.g., AS, AF, NF, network component). A consumer application (e.g., AC, DEAS) on a WTRU or a consumer application (e.g., AS) in the network may use the DEEF functionality provided by the DEEF.

The DEEF functionality may be packaged in a library that may be statically linked with an application (e.g., AC, DEAS or AS), or dynamically loaded by an application (e.g., AC, DEAS or AS). A DEEF may alternatively be deployed as a standalone functional element in a WTRU or in a DN. For example, the DEEF may be deployed as an EC on a WTRU and/or as an ES in a DN. The consumer applications (e.g., AC, DEAS) on a WTRU may access functionality provided by the EC via a determined API or interface. The consumer applications (e.g., AS) in the network may access functionality provided by the ES via a determined API or interface.

The DEEF may (e.g., alternatively) be deployed in an EC that does not reside on the same WTRU as the consumer application (e.g., AC, DEAS). For example, a consumer application (e.g., AC, DEAS) deployed on a TE may use attention commands (AT commands) to interact with an EC deployed in a mobile termination (MT) part of the WTRU. For example, a consumer application (e.g., AC, DEAS) deployed on a TE may interact with an EC that may be also deployed in the TE part of the WTRU. For example, a consumer application (e.g., AC, DEAS) may use a tethered connection (e.g., a D2D connection such as Bluetooth, WiFi, or PC5) to communicate with an EC that runs in the WTRU.

In a mobile network, a DECF may provide device edge configuration services to a WTRU (e.g., DEEF). Device edge configuration services may include procedures for configuring connectivity for a DEAS.

The DECF may offer device edge configuration services via an API. The DECF functionality may be implemented as a standalone AF or as a NF. The DECF functionality may be combined with an existing AF or NF, and the API may be offered as an extension of an existing API and the API may be based on a NAS interface or a service-based interface.

The DECF services may be offered using a communication protocol. For example, the HTTP or the Non-Access stratum (NAS) protocol for 5G systems may provide access to the capabilities of the DECF services. When offered via the NAS protocol, a consumer of DECF services may interact directly with an AMF or with the AMF via a network exposure function (NEF) to communicate with the DECF. If the consumer is a first WTRU, the first WTRU may send a NAS message to the AMF and the AMF may communicate with a DECF located in the network via a service-based message.

The DECF may be located in the network (e.g., AS, AF, NF, network component). A consumer DEEF (e.g., on a WTRU or in the network) may use the DECF functionality provided by the DECF.

The DECF functionality may be packaged in a library that may be statically linked with an AS, or dynamically loaded by an AS. A DECF may alternatively be deployed as a standalone functional element in a DN. For example, the DECF may be deployed as an ES in a DN. The AS may access functionality provided by the ES via a determined API or interface.

In a mobile network, a DERF may provide device edge registry services to a WTRU (e.g., DEEF on a WTRU) and to a network (e.g., DEEF in a network). Device edge registry services may include procedures for registering and discovering a DEAS.

The DERF may offer device edge enablement services via an API. The DERF functionality may be implemented as a standalone AF or as a NF. The DERF functionality may be combined with an existing AF or NF, and the API may be offered as an extension of an existing API and the API may be based on a NAS interface or a service-based interface.

The DERF services may be offered using a communication protocol. For example, the HTTP or the Non-Access stratum (NAS) protocol for 5G systems may provide access to the capabilities of the DERF services. When offered via the NAS protocol, the consumer of DERF services may interact directly with an AMF or with the AMF via a NEF to communicate with the DERF. If the consumer is a first WTRU, the first WTRU may send a NAS message to the AMF and the AMF may communicate with a DERF located in the network via a service-based message or with a DERF located on a second WTRU via a second NAS message.

The DERF may be located on a WTRU (e.g., terminal component) or in the network (e.g., AS, AF, NF, network component). A consumer DEEF (e.g., on a WTRU or in the network) may use the DERF functionality provided by the DERF.

The DERF functionality may be packaged in a library that may be statically linked with an AS, or dynamically loaded by an AS. A DERF may alternatively be deployed as a standalone functional element in a WTRU or in a DN. For example, the DERF may be deployed as an ES in a DN or on a WTRU. The AS may access functionality provided by the ES via a determined API or interface.

The DEEF, DECF and DERF may support DEAS registration and DEAS connectivity configuration. DEAS registration may allow a DEAS provider to expose services running at a device edge (e.g., on a WTRU or in a device edge DN). DEAS connectivity configuration may allow a DEAS provider to configure or request assistance from a DECF to configure DEAS connectivity.

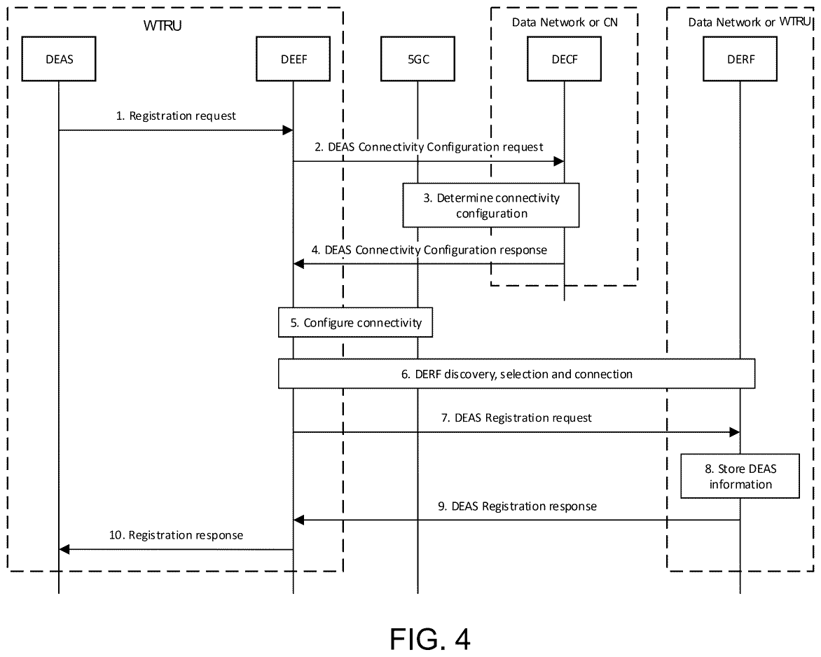

Referring to FIG. 4, a procedure for DEAS registration and configuration is shown. A DEAS may determine an application layer need to expose device edge services. Determining an application layer need to expose device edge services means that the DEAS may evaluate a configuration (e.g., pre-configured or obtained from the network), may evaluate a received message, may evaluate a user request (e.g., via an API) and may conclude from the evaluation that device edge services need to be expose.

In a first stage (e.g., steps 2 to 5 of FIG. 4), a device edge WTRU may configure its connectivity for offering device edge services. To make the DEAS accessible, the DEEF may configure WTRU connectivity for providing edge services by communicating with a DECF in the network. If the DEAS is aware of the required and/or preferred WTRU connectivity configuration, the DEAS may provide the WTRU connectivity configuration information to the DEEF, and the DEEF may provide the required and/or preferred WTRU connectivity configuration information to the DECF to be validated. Otherwise, the DEEF may request the DECF to determine the required WTRU connectivity configuration information. The DECF may validate or may determine the WTRU connectivity configuration information based on DEAS preferences (e.g., WTRU connectivity preferences in the DEAS profile), WTRU capabilities, and core network capabilities and state. The DEEF may configure WTRU connectivity by performing local connectivity configuration and/or by requesting the DECF to configure WTRU connectivity via the core network.

In a second stage (e.g., steps 6 to 9 of FIG. 4), the device edge WTRU may register to a DERF to enable its discoverability as a device edge node. To make the DEAS discoverable, the DEEF may register the DEAS with the DERF. The DEEF may discover, may select and may connect to the DERF. The DERF may store the DEAS information provided by the DEEF. The DEAS information may be used to identify matching DEAS instances during DEAS discovery.

More particularly, referring to FIG. 4, in step 1, the DEAS may send a registration request to the DEEF (e.g., to make the DEAS discoverable and accessible). The request may include any of: (i) a DEAS profile, (ii) WTRU connectivity configuration information, and (iii) DEAS connection information described herein. If a registration already exists for a DEAS, then the DEAS may send a registration update request to the DEEF to provide updates to any information in the DEAS profile and to inform the DEEF about any changes to the WTRU connectivity and/or WTRU connectivity configuration information.

For example, a spatial mapping drone WTRU with cameras and sensors may wish to offer sensing and drone control services to local and remote users. The drone service provider may create a DEAS profile for the sensing and drone control services. The DEAS profile may include a service identifier, service type, service endpoint information, and other information that characterizes the services. The DEAS profile may (e.g., additionally) include service access permissions for local and remote users, an indication that the drone service provider may prefer ProSe connectivity for local users and prefers 5G virtual network (VN) connectivity for remote users, and an indication that the network (e.g., DECF) should determine the required connectivity configuration. The drone services may provide the DEAS profile while registering with the DEEF.

Note that in this example the drone service provider may not include pre-configured or preferred WTRU connectivity configuration information in the registration request to the DEEF. However, the drone service provider could include WTRU connectivity configuration information if preferred and/or required.

Referring to FIG. 4, in step 2, the DEEF may send a DEAS connectivity configuration request to the DECF. The request may include security credentials, a DEAS profile, WTRU information and WTRU connectivity configuration information described herein.

For example, the DEEF may provide the spatial mapping drone DEAS profile and WTRU connectivity configuration information to the DECF in the DEAS connectivity configuration request. The DEEF may additionally include WTRU information in the request to indicate that the drone may support LTE, 5G NR, NR-PC 5 and Wi-Fi RATs, and that the drone may support 5G VN, ProSe and PIN connectivity.

Referring to FIG. 4, in step 3, the DECF may determine whether the DEEF is authorized to request connectivity configuration information for a DEAS. If authorized, the DECF may use the DEAS Profile, WTRU information, and WTRU connectivity configuration information to validate and/or determine the connectivity configuration information for the requesting DEAS. Otherwise, the DECF may indicate an error in the response.

If the DEAS profile indicates that the connectivity configuration is provided by the DEAS, the DECF may validate that the provided WTRU connectivity configuration information is valid. The DECF may also configure the core network to support the requested WTRU connectivity. For example, the DECF may communicate with the core network (e.g., via a NEF) to verify that the provisioned ProSe application ID is not already in use and to configure the requested 5G VN.

If the DEAS Profile indicates that the network should determine and provide connectivity configuration information, the DECF may determine the connectivity configuration information based on the connectivity preferences in the DEAS profile, the connectivity capabilities in the WTRU information, and information obtained from the core network about supported and available connectivity methods.

For example, the spatial mapping drone DEAS profile may indicate that the DECF should determine the connectivity configuration. Based on connectivity preferences in the DEAS profile and supported RAT types and connectivity capabilities from the WTRU information, the DECF may determine that a 5G VN is required for remote connections to the drone services, and that ProSe should be used for local connections. The DECF may communicate with the core network (e.g., via a NEF) to obtain information about existing 5G VNs and to ProSe applications. The DECF may use this information to determine the connectivity configuration for the drone services. The DECF may also update WTRU policies (e.g., URSP, ProSe Policy) (e.g., via a policy control function (PCF) in the core network to configure WTRU connectivity).

It can be appreciated that a device edge WTRU may have a subscription with a mobile network operator (MNO) for offering device edge services. The subscription may be associated with a connectivity configuration for the device edge WTRU and connectivity configuration information for device edge services may be stored in the core network (e.g., in the unified data repository (UDR) by the unified data management (UDM)). The device edge connectivity configuration stored in the core network may contain an indication of whether the connectivity for device edge is enabled or disabled. The connectivity information received in the DEAS connectivity configuration request may include WTRU identifier(s) and/or subscription identifier(s) corresponding to the device edge connectivity configuration stored in the core network. Upon receiving the DEAS connectivity configuration request, the DECF may use the WTRU identifier(s) and/or subscription identifier(s) to interact with the core network (e.g., to interact with the UDM and UDR either directly or via the NEF) for enabling or disabling the connectivity configuration stored in the core network. Upon enabling or disabling the device edge connectivity in the core network, the UDM may notify the AMF and/or SMF about the enablement and/or disablement of the configuration, and the AMF and/or SMF may perform actions for enabling or disabling the connectivity according to the subscription. For example, the device edge connectivity configuration stored in the core network may indicate that a network slice may need to be created for offering device edge services. For example, the device edge connectivity configuration stored in the core network may indicate that a PIN needs to be created for offering device edge services or that ProSe connectivity may need to be configured.

Referring to FIG. 4, in step 4, the DECF may send a DEAS connectivity configuration response to the DEEF. The DEAS connectivity configuration response may include WTRU connectivity configuration information and DEAS connection information described herein. The WTRU connectivity configuration information may be used to configure connectivity for the WTRU where the DEAS is hosted. DEAS connection information may be used to configure connectivity for a WTRU or network node that may wish to establish a connection to the DEAS. The DECF may determine the DEAS connection information based on the determined WTRU connectivity configuration information.

For example, based on the determined connectivity configuration for the drone services, the DECF may determine the DEAS connection information for local and remote users. The DEAS connection information may include a ProSe application ID and ProSe application code for local users to use to establish a D2D connection with the drone and to avail the drone services. The DEAS connection information may also include the DNN to use for remote connections to the 5G VN where the drone services are available.

Referring to FIG. 4, in step 5, the DEEF may use the WTRU connectivity configuration information to configure WTRU connectivity. The DEEF may update the DEAS connection information based on the results of configuring WTRU connectivity. For example, the DEEF may use the WTRU connectivity configuration information to trigger the establishment of a PDU session to a 5G VN DNN. The DEEF may use the WTRU connectivity configuration information to configure the ProSe application using the provided ProSe application ID and ProSe application code or join a PIN as indicated in the DEAS connectivity configuration response.

Referring to FIG. 4, in step 6, the DEEF may discover a DERF (e.g., a local DERF on a WTRU or a DERF residing in a data network). The DEEF may select the DERF. The DEEF may establish connectivity to the DERF. The DEEF may connect to the DERF by establishing a D2D connection, joining a PIN, joining a 5G VN, or establishing a PDU session to a data network (e.g., an EDN or a device edge DN on another device).

Referring to FIG. 4, in step 7, the DEEF may send a DEAS registration request to the DERF. The DEAS registration request may include any of: (i) security credentials, (ii) a DEEF ID (e.g., a unique identifier), (iii) WTRU information, (iv) a DEAS profile, and (v) DEAS connection information described herein. The DEAS connection information may include information received from the DEAS, received from the DECF, and/or determined by the DEEF.

Referring to FIG. 4, in step 8, the DERF may determine whether the DEEF is authorized to register a DEAS. If authorized, the DERF may store the WTRU information, the DEAS profile and the DEAS connection information. Otherwise, the DERF may indicate an error in the response. For example, the DERF may store the WTRU information, the DEAS profile and DEAS connection information for an authorized DEEF in a local database. Using the WTRU information, the DERF may communicate with the core network location services (e.g., via the NEF) to obtain information about the location or predicted location of the WTRU where the DEAS is hosted.

Referring to FIG. 4, in step 9, the DERF may send a DEAS registration response to the DEEF. The DEAS registration response may include an indication about whether the DEAS was successfully registered. The DEAS registration response may include a (e.g., unique) DEAS registration identifier that may be used during subsequent calls to the DERF to identify the stored DEAS information (e.g., DEAS profile and DEAS connection information).

Referring to FIG. 4, in step 10, the DEEF may send a DEAS registration response to the DEAS. The DEAS registration response may include an indication about whether the DEAS was successfully registered. The DEAS registration response may include the (e.g., unique) DEAS registration identifier that may be used during subsequent calls to the DEEF to identify the stored DEAS information.

The DEEF may support WTRU-requested DEAS discovery. The DERF may support WTRU-requested DEAS discovery. WTRU-requested DEAS discovery may enable an AC on a WTRU to discover DEAS instances based on requestor information, WTRU information and DEAS discovery filters. An AC on a WTRU may determine an application layer need to discover local edge services at a device edge (e.g., on a WTRU or in a device edge DN). The AC may send a request to a DEEF to discover local DEAS instances of interest. The DEAS instances of interest may be available and/or accessible DEAS instances of interest.

To discover DEAS instances, the DEEF may discover a DERF. The DEEF may select the DERF. The DEEF may establish connectivity with a DERF. The DERF selection may be based on any of AC information, WTRU information and DEAS discovery filters. The DEEF may send a request to the DERF to discover DEAS instances of interest. The DERF may verify that the requestor DEEF and AC are allowed to perform the discovery. The DERF may identify DEAS instances that match the provided DEAS discovery filters. The DERF may return the DEAS information (e.g., DEAS profile and/or DEAS connection information) for the identified DEAS instances of interest to the DEEF. The DEEF may provide the discovered DEAS information to the AC. The AC may select, and may establish connectivity with, and begin using the services of the DEAS.

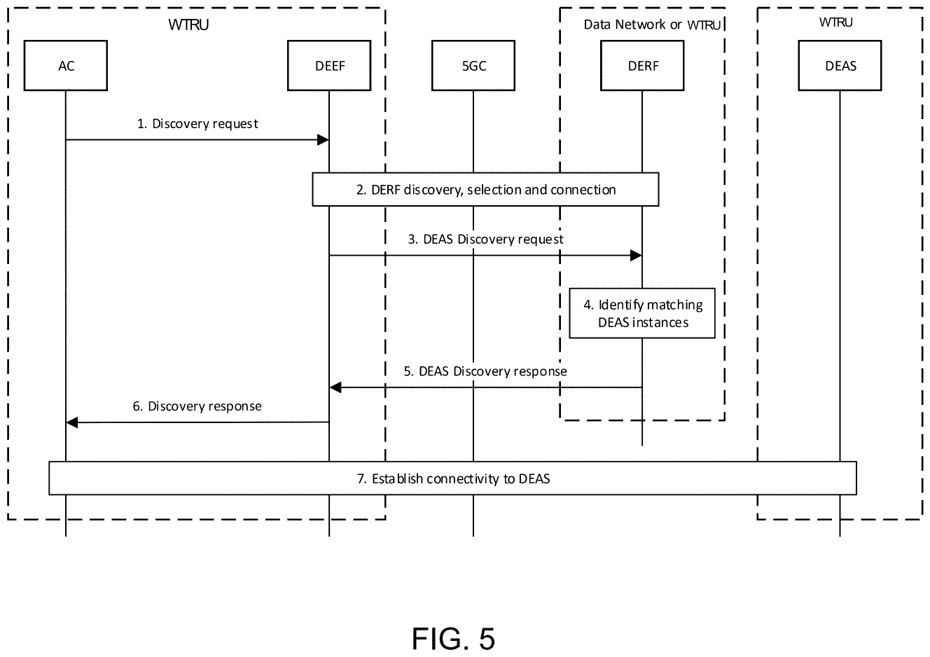

Referring to FIG. 5, an example of a procedure for WTRU-requested DEAS discovery is shown. The DEAS registration procedure described in FIG. 4 may be performed to register one or more DEAS instances. For example, a set of spatial mapping drones offer sensing and drone control services may register with a DERF.

Referring to FIG. 5, in step 1, an AC on a WTRU may send a discovery request to a DEEF. The discovery request may include requestor information. The discovery request may include DEAS discovery filters described herein. For example, a spatial mapping application wishes to discover and control available spatial mapping drones in an area of interest. The spatial mapping application may determine DEAS discovery filters that characterize the required drone services (e.g., a service identifier, service type, and other information that characterizes the services). The spatial mapping application may (e.g., additionally) provide (e.g., in the DEAS discovery filters) an area of interest where spatial mapping is required. The spatial mapping application may (e.g., additionally) provide an indication that it prefers ProSe for local connections and 5G VN for remote connections to drone services. The spatial mapping application may provide the DEAS discovery filters while performing DEAS discovery with the DEEF.

Referring to FIG. 5, in step 2, the DEEF may discover a DERF. The DEEF may select the DERF (e.g., a local DERF on a WTRU or a DERF residing in a data network). The DEEF may establish connectivity to the DERF. The DEEF may connect to the DERF by establishing a D2D connection, joining a PIN, joining a 5G VN, or establishing a PDU session to a data network (e.g., an EDN or a device edge DN on another device).

Referring to FIG. 5, in step 3, the DEEF may send a DEAS discovery request to the DERF. The DEAS discovery request may include any of: (i) security credentials, (ii) a DEEF ID (e.g., a unique identifier), (iii) a requestor information, (iv) WTRU information, and (v) DEAS discovery filters described herein. For example, in the DEAS discovery request, the DEEF may include the DEAS discovery filters (e.g., the filters received from the spatial mapping application) and/or information about the requestor (e.g., the spatial mapping application). The DEEF may (e.g., additionally) include WTRU information to indicate any of the following: (i) that the requestor WTRU (e.g., the UE on which the DEEF making the request resides) may support LTE, 5G NR, NR-PC 5 and Wi-Fi RATs, (ii) that the requestor WTRU may support 5G VN, ProSe and PIN connectivity, (iii) that the requestor WTRU may be currently at a specific geographical location, and (iv) that the requestor WTRU may be planning to move along a predefined path over time.

Referring to FIG. 5, in step 4, the DERF may determine whether the DEEF is authorized to discover a DEAS. If authorized, the DERF may use any of: (i) the requestor information, (ii) WTRU information, and (iii) DEAS discovery filters, to identify relevant DEAS instances. Otherwise, the DERF may indicate an error in the response.

To identify relevant DEAS instances, the DERF may compare the information provided in the discovery request with the information provided by the DEAS instances during registration. The DERF may also compare the requestor WTRU location or predicted location with the registered DEAS instance locations, predicted locations and coverage areas to identify DEAS instances that are currently relevant and will continue to be relevant as the requestor WTRU changes location. Using the WTRU information, the DERF may communicate with the core network location services (e.g., via the NEF) to obtain information about the requestor WTRU location or predicted location.

If the DERF is unable to find a relevant DEAS instance, the DERF may communicate with other DERF instances to determine whether they have relevant DEAS instances. The DERF may provide to other DERF instances any information obtained in the DEAS discovery request from the DEEF. The DERF may obtain information about the relevant DEAS instances directly from the other DERF instances. Alternatively, the DERF may provide a list of DERF instances (e.g., that have relevant DEAS instances) in the response to the DEEF.

For example, the DERF may determine that there are multiple drone services available within the area of interest of the spatial mapping application. The DERF may make this determination by comparing the requested DEAS identifiers and types in the DEAS discovery filters with the registered DEAS instance profiles. The DERF may also make this determination by comparing the requested area of interest with the registered DEAS instance coverage areas.

For example, the DERF may determine that there is only one drone service within the area of interest of the spatial mapping application that supports ProSe communication and that is within range of the requestor WTRU. This determination may be made by comparing the location and preferred RATs and connectivity methods of the spatial mapping application and WTRU with the location and supported RATs and connectivity methods of the registered DEAS instances.

Referring to FIG. 5, in step 5, the DERF may send a DEAS discovery response to the DEEF. The DEAS discovery response may include any of: (i) information about the discovered DEAS instances, (ii) an indication that the request was not authorized, (iii) an indication that no relevant DEAS instances were identified, and (iv) an indication that relevant DEAS instances may be available at another DERF. Information about the discovered DEAS instances may include a DEAS Profile and/or DEAS connection information for each DEAS instance.

If the response indicates that the DERF was unable to identify a relevant DEAS instance, or if the response indicates that relevant DEAS instances may be available at another DERF, the DEEF may establish connectivity with another DERF. If the response indicates that the DERF was unable to identify a relevant DEAS instance, or if the response indicates that relevant DEAS instances may be available at another DERF, the DEEF may send a DERF discovery request to this other DERF.

Referring to FIG. 5, in step 6, the DEEF may send a discovery response to the AC. The discovery response may include any of (i) information about the discovered DEAS instances, (ii) an indication that the request was not authorized, and (iii) an indication that no relevant DEAS instances were identified. Information about the discovered DEAS instances may include a DEAS profile and/or DEAS connection information for each DEAS instance.

Not shown in the FIG. 5, the DEEF may select a DEAS instance from a list of discovered DEAS instances and/or may use the associated DEAS connection information to trigger the requestor WTRU to establish connectivity with the WTRU where the selected DEAS instance is hosted.

The discovery response may include connectivity information needed to establish connectivity with the WTRU offering the device edge service (e.g., hosting the DEAS). For example, the connectivity information may include ProSe parameters that are needed for the first WTRU to discover the device edge WTRU and establish the connectivity. For example, the connectivity information may include PIN parameters needed for the first WTRU to join a PIN where the device edge WTRU is providing the device edge service. For example, the connectivity information may include a device edge WTRU and/or subscription identifier(s) associated with a communication profile. The AC and/or DEEF may use any of: (i) the device edge WTRU identifier, (ii) the device edge subscription identifier, and (iii) the AC and/or DEEF identifier(s) to interact with the core network (e.g., to interact with the UDM and UDR either directly or via the NEF) for enabling or disabling connectivity between the AC and the device edge WTRU (e.g., DEAS) according to a configuration stored in the core network (e.g., UDM, UDR). Upon enabling or disabling connectivity, the UDM may notify the AMF and/or SMF about the enablement and/or disablement of the configuration. The AMF and/or SMF may perform actions for enabling or disabling the connectivity between the AC and device edge WTRU (e.g., DEAS) according to the subscription.

Referring to FIG. 5, in step 7, the AC may connect to the selected DEAS instance. The AC may select a DEAS instance from the list of discovered DEAS instances. The AC may use the associated DEAS connection information to trigger the requestor WTRU to establish connectivity with the WTRU where the selected DEAS instance is hosted. The AC may then use the services of the selected DEAS instance.

For example, the spatial mapping application may trigger the establishment of a D2D connection with the drone. The spatial mapping application may start using the drone services to control the drone movement. The spatial mapping application may obtain spatial mapping sensor information from the drone. For example, the spatial mapping application may trigger the establishment of a ProSe Layer-3 WTRU-to-Network relay connection outside of a PDU session. For example, the spatial mapping application may use a FQDN, PIN ID or a DNN that was received in a discovery response to trigger the establishment of a ProSe Layer-3 WTRU-to-Network relay connection outside of a PDU session. In other words, the FQDN, PIN ID or DNN (e.g., or any information from the DEAS connection information) may be used as a traffic descriptor to trigger the connection.

For example, the spatial mapping application may trigger the establishment of a PDU session. The PDU session may be used to send traffic to the selected DEAS instance. For example, the spatial mapping application may use a FQDN, PIN ID or a DNN that was received in the discovery response to trigger the establishment of a PDU Session. In other words, the FQDN, PIN ID or DNN (e.g., or any information from the DEAS connection information) may be used as a traffic descriptor to trigger the PDU Session.

Once a PDU session or a ProSe Layer-3 WTRU-to-Network relay connection outside of a PDU session may be established. The spatial mapping application may use an IP address to send a message to the DEAS instance. The IP address may have been received in the discovery response.

The DEEF may support network-requested DEAS discovery. The DERF may support network-requested DEAS discovery. Network-requested DEAS discovery may enable an AS in a network (e.g., in an EDN or in a cloud DN) to discover DEAS instances based on requestor information and DEAS discovery filters.

An AS in a network may determine an application layer need to discover local edge services at a device edge (e.g., on a WTRU or in a device edge DN). The AS may send a request to a DEEF to discover available and/or accessible DEAS instances of interest.

To discover DEAS instances, the DEEF may discover, may select and may establish connectivity with a DERF. DERF selection may be based on AS information and/or DEAS discovery filters. The DEEF may send a request to the DERF to discover DEAS instances of interest. The DERF may verify that the requestor DEEF and/or AS may be allowed to perform the discovery. The DERF may identify DEAS instances that may match the provided DEAS discovery filters. The DERF may return the DEAS information (e.g., DEAS profile and/or DEAS connection information) for the identified DEAS instances of interest to the DEEF. The DEEF may provide the discovered DEAS information to the AS. The AS may select, may establish connectivity with, and may begin using the services of the DEAS.

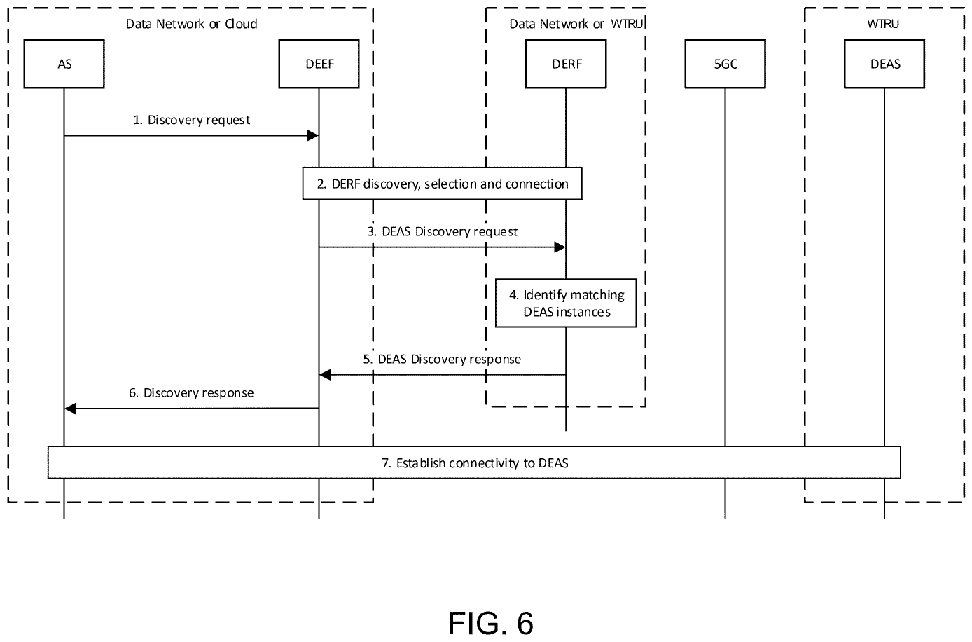

Referring to FIG. 6, an example of a procedure for network-requested DEAS discover is shown. The DEAS registration procedure described in FIG. 4 may be performed to register one or more DEAS instances. For example, a set of spatial mapping drones offer sensing and drone control services may register with a DERF.

Referring to FIG. 6, in step 1, an AS in a network may send a discovery request to a DEEF. The discovery request may include requestor information and/or DEAS discovery filters described herein. For example, a spatial mapping AS may wish to discover and control available spatial mapping drones in an area of interest. The spatial mapping AS may determine DEAS discovery filters that may characterize the required drone services (e.g., a service identifier, service type, and other information that characterizes the services). The spatial mapping AS may (e.g., additionally) provide (e.g., in the DEAS discovery filters) the area of interest where spatial mapping is required. The spatial mapping AS may provide the DEAS discovery filters while performing DEAS discovery with the DEEF.

Referring to FIG. 6, in step 2, the DEEF may discover a DERF (e.g., on a WTRU or a DERF residing in a data network). The DEEF may select the DERF. The DEEF may establish connectivity to the DERF. The DEEF may connect to the DERF by connecting to a PIN, connecting to a 5G VN, or connecting to a data network where the DERF is running.

Referring to FIG. 6, in step 3, the DEEF may send a DEAS discovery request to the DERF. The DEAS discovery request may include any of: (i) security credentials, (ii) a DEEF ID (e.g., a unique identifier), (iii) requestor information, and (iv) DEAS discovery filters described herein. For example, in the DEAS discovery request, the DEEF may include the DEAS discovery filters (e.g., the filters received from the spatial mapping AS) and/or information about the requestor (e.g., the spatial mapping AS).

Referring to FIG. 6, in step 4, the DERF may determine whether the DEEF is authorized to discover a DEAS. If authorized, the DERF may use the requestor information and/or DEAS discovery filters to identify relevant DEAS instances. Otherwise, the DERF may indicate an error in the response.

To identify relevant DEAS instances, the DERF may compare the information provided in the discovery request with the information provided by the DEAS instances during registration. If the DERF is unable to find a relevant DEAS instance, the DERF may communicate with other DERF instances to determine whether they have relevant DEAS instances. The DERF may provide to other DERF instances any information obtained in the DEAS discovery request from the DEEF. The DERF may obtain information about the relevant DEAS instances directly from the other DERF instances. Alternatively, the DERF may provide a list of DERF instances (e.g., that have relevant DEAS instances) in the response to the DEEF.

For example, the DERF may determine that there are multiple drone services available within the area of interest of the spatial mapping AS. The DERF may make this determination by comparing the requested DEAS identifiers and types in the DEAS discovery filters with the registered DEAS instance profiles, and/or by comparing the requested area of interest with the registered DEAS instance coverage areas.

Referring to FIG. 6, in step 5, the DERF may send a DEAS discovery response to the DEEF. The DEAS discovery response may include any of: (i) information about the discovered DEAS instances, (ii) an indication that the request was not authorized, (iii) an indication that no relevant DEAS instances were identified, and (iv) an indication that relevant DEAS instances may be available at another DERF. Information about the discovered DEAS instances may include a DEAS Profile and/or DEAS connection information for each DEAS instance.

If the response indicates that the DERF was unable to identify a relevant DEAS instance, or if the response indicates that relevant DEAS instances may be available at another DERF, the DEEF may establish connectivity with another DERF. the DEEF may send a DERF discovery request to this other DERF.

Referring to FIG. 6, in step 6, the DEEF may send a discovery response to the AS. The discovery response may include any of: (i) information about the discovered DEAS instances, (ii) an indication that the request was not authorized, and (iii) an indication that no relevant DEAS instances were identified. Information about the discovered DEAS instances may include a DEAS profile and/or DEAS connection information for each DEAS instance.

Not shown in FIG. 6, the DEEF may select a DEAS instance from the list of discovered DEAS instances. The DEEF may use the associated DEAS connection information to establish connectivity with the WTRU where the selected DEAS instance is hosted.

The discovery response may include connectivity information needed to establish connectivity with the WTRU offering the device edge service (e.g., hosting the DEAS). For example, the connectivity information may include a network slice identifier that the AS may use to establish connectivity with the DEAS. For example, the connectivity information may include a WTRU identifier(s) and/or subscription identifier(s) associated with a communication profile. The AS and/or DEEF may use any of: (i) the WTRU identifier, (ii) the subscription identifier, and (iii) the AS and/or DEEF identifier(s) to interact with the core network (e.g., to interact with the UDM and/or UDR either directly or via the NEF) for enabling or disabling connectivity between the AS and the device edge WTRU (e.g., DEAS) according to a configuration stored in the core network (e.g., UDM, UDR). Upon enabling or disabling connectivity, the UDM may notify the AMF and/or SMF about the enablement and/or disablement of the configuration. The AMF and/or SMF may perform actions for enabling or disabling the connectivity between the AS and device edge WTRU (e.g., DEAS) according to the subscription.

Referring to FIG. 6, in step 7, the AS may connect to the selected DEAS instance. The AS may select a DEAS instance from the list of discovered DEAS instances. The AS may use the associated DEAS connection information to establish connectivity with the WTRU where the selected DEAS instance is hosted. The AS may use the services of the selected DEAS instance. For example, the spatial mapping AS may connect to the 5G VN where the drone services are available. The spatial mapping AS may start using the drone services to control the drone movement and/or to obtain spatial mapping sensor information from the drone.

In an embodiment, a WTRU (e.g., an enabler client with DEEF capabilities) may perform any of the following steps to register and configure connectivity for device edge services. At a first step, the WTRU may receive a request to register a DEAS. The request may be received based on an application layer need to expose a device edge service. The request may be received from a (e.g., another or the same) WTRU hosted DEAS via a message or an API. The request may include any of: (i) a DEAS profile, (ii) a WTRU connectivity configuration, and (iii) DEAS connection information. The DEAS profile may include any of: (i) information from the EAS profile, (ii) DEAS access permissions, (iii) WTRU connectivity configuration information including WTRU connectivity configuration requirements, and/or WTRU connectivity configuration preferences. The WTRU connectivity configuration information may include any of: (i) data network information, (ii) a ProSe policy and ProSe parameters, and (iii) PIN configuration information. DEAS connection information may include any of: (i) data network information, (ii) ProSe discovery filters, (iii) PIN information, and (iv) DEAS endpoint information.

At a second step, the WTRU may send a DEAS connectivity configuration request to the network to configure how the device edge services or data can be accessed by device edge service consumers. The request may be sent based on receiving the request to register the DEAS, and based on the application layer need to expose a device edge service. The request may be sent based on receiving the request to register the DEAS from the (e.g., same or another) WTRU hosted the DEAS via a message or an API. The request may be sent to a network functional entity with DECF capabilities. The request may include any of: (i) the DEAS profile, (ii) WTRU information, and (iii) WTRU connectivity configuration information. WTRU information may include any of: (i) a WTRU identifier, (ii) a WTRU state, and (iii) WTRU capabilities. The WTRU capabilities may include any of: (i) supported radio access technologies, (ii) connectivity capabilities, (iii) processing capabilities, and (iv) AI/ML processing capabilities. The functional entity with DECF capabilities may use any of (i) the DEAS profile, (ii) WTRU information, and (iii) a WTRU connectivity configuration information to validate and/or determine the DEAS connectivity configuration for the requesting DEAS.

At a third step, the WTRU may receive a DEAS connectivity configuration response from the network. The response may be received from a network functional entity with DECF capabilities. The response may be provided to the DEEF of the WTRU. The response may include DEAS connectivity configuration information. DEAS connectivity configuration information may include WTRU connectivity configuration information (e.g., to configure the WTRU connectivity) and/or DEAS connection information (e.g., to indicate how to connect to the DEAS).

At a fourth step, the WTRU may use the WTRU connectivity configuration information to configure WTRU connectivity for exposing device edge services. The DEEF of the WTRU may trigger the configuration of WTRU connectivity. The DEEF may select one or more of connection methods from the WTRU connectivity configuration information to configure WTRU connectivity (e.g., by triggering the establishment of a PDU session to access a data network, configuring a ProSe Policy in a ProSe application on the WTRU, and/or creating or joining a PIN). The WTRU may (e.g., alternatively) receive WTRU connectivity configuration information (e.g., via policy (e.g., URSP, ProSe Policy) updates from a PCF in the core network).

At a fifth step, the WTRU may send a DEAS registration request to the network to expose device edge services to device edge service consumers. The DEAS registration request may be sent based on receiving the request to register the DEAS from the application layer need to expose a device edge service. The DEAS registration request may be sent based on receiving the request to register the DEAS from (e.g., the same or another) WTRU hosted DEAS via a message or an API. The request may be sent to a network functional entity with DERF capabilities. The request may include the DEAS profile and the DEAS connection information. The DEAS connection information may include any of: (i) information received from the DEAS, (ii) information received from the DECF, and (iii) information determined by the DEEF. The functional entity with DERF capabilities may store this information.

At a sixth step, the WTRU may receive a DEAS Registration response from the network. The response may be received from a network functional entity with DERF capabilities. The response may include a DEAS registration ID for the newly registered DEAS. The response may be provided to the DEEF of the WTRU. The DEEF may store the DEAS registration ID. The DEEF may provide the DEAS registration ID to the DEAS that requested registration. The AC may store the DEAS registration ID. The AC may use the DEAS registration ID for managing the registered DEAS (e.g., for example to modify a registered DEAS connectivity configuration, or to deregister a DEAS).

In another embodiment, a WTRU (e.g., an enabler client with DEEF capabilities) may perform any of the following steps to discover device edge services. At a first step, the WTRU may receive a request to discover a DEAS. The request may be received based on an application layer need to use a device edge service. The request may be received from a from a (e.g., another or the same) WTRU hosted AC via a message or an API. The request may include requestor information and/or DEAS discovery filters. Requestor information may include any of: (i) a user identifier, (ii) an AC identifier, and (iii) an AC type. DEAS discovery filters may include any information from the DEAS profile. DEAS discovery filters may include WTRU connectivity preferences.

At a second step, the WTRU may send a DEAS discovery request to the network to discover registered device edge services. The request may be sent based on receiving a request to discover device edge services. The request may be sent to a network functional entity with DERF capabilities. The request may include any of: (i) the requestor information, (ii) DEAS discovery filters, and (iii) WTRU information. WTRU information may include any of: (i) a WTRU identifier, (ii) WTRU state, and (iii) WTRU capabilities. WTRU capabilities may include any of: (i) supported radio access technologies, (ii) connectivity capabilities, (iii) processing capabilities, and (iv) AI/ML processing capabilities. The functional entity with DERF capabilities may use, to identify matching DEAS instances, any of: (i) the requestor information, (ii) DEAS discovery filters, and (iii) WTRU information.

At a third step, the WTRU may receive a DEAS discovery response from the network. The response may be received from a network functional entity with DERF capabilities. The response may include a list of DEAS Profiles and/or DEAS connection information for the discovered DEAS instances. DEAS connection information may include any of: (i) data network information, (ii) ProSe discovery filters, (iii) PIN information, and (iv) DEAS endpoint information. The response may be provided to the DEEF of the WTRU. The DEEF may store the list of discovered DEAS instances. The DEEF may provide the list of discovered DEAS instances to the AC that requested the discovery.

At a fourth step, the AC may store the DEAS connection information. The AC may use the DEAS connection information to connect to the selected DEAS instance.

An embodiment with steps similar to the above steps may occur when an AS in the network (e.g., with DEEF capabilities) requests the discovery of DEAS instances, with the exception that information about the requesting WTRU is excluded.

In another embodiment, a network node (e.g., a network functional entity, an application server, or an enabler server, with DECF capabilities) may perform any of the following steps to configure connectivity for device edge services. At a first step, the network node may receive a DEAS connectivity configuration request to configure how the device edge services or data can be accessed by device edge service consumers. The request may be received from a WTRU with DEEF capabilities. The request may be provided to the DECF of the network node. The request may include any of a (i) DEAS profile, (ii) WTRU information, and (iii) WTRU connectivity configuration information. The DEAS profile may include any information from the EAS profile. The DEAS profile may include DEAS access permissions. The DEAS profile may include WTRU connectivity configuration requirements. The DEAS profile may include WTRU connectivity configuration preferences. WTRU information may include any of: (i) a WTRU identifier, (ii) a WTRU state, and (iii) WTRU capabilities. WTRU capabilities may include any of: (i) supported radio access technologies, (ii) connectivity capabilities, (iii) processing capabilities, and (iv) AI/ML processing capabilities. WTRU connectivity configuration information may include any of: (i) data network information, (ii) a ProSe Policy, (iii) ProSe parameters, and (iv) PIN configuration information

At a second step, the network node may use, to validate and/or determine the DEAS connectivity configuration for the requesting DEAS, any of: (i) the DEAS profile, (ii) WTRU information, and (iii) WTRU connectivity configuration information. The network node may update WTRU policies (e.g., URSP, ProSe Policy) (e.g., via the PCF in the core network).

At a third step, the network node may send a DEAS connectivity configuration response to the WTRU to indicate the required connectivity configuration for exposing device edge services to local and/or remote consumers. The response may be sent to a WTRU with DEEF capabilities. The response may include DEAS connectivity configuration information. DEAS connectivity configuration information may include WTRU connectivity configuration information (e.g., to configure the WTRU connectivity) and/or DEAS connection information (e.g., to indicate how to connect to the DEAS). The WTRU may use the WTRU connectivity configuration information to configure WTRU connectivity.

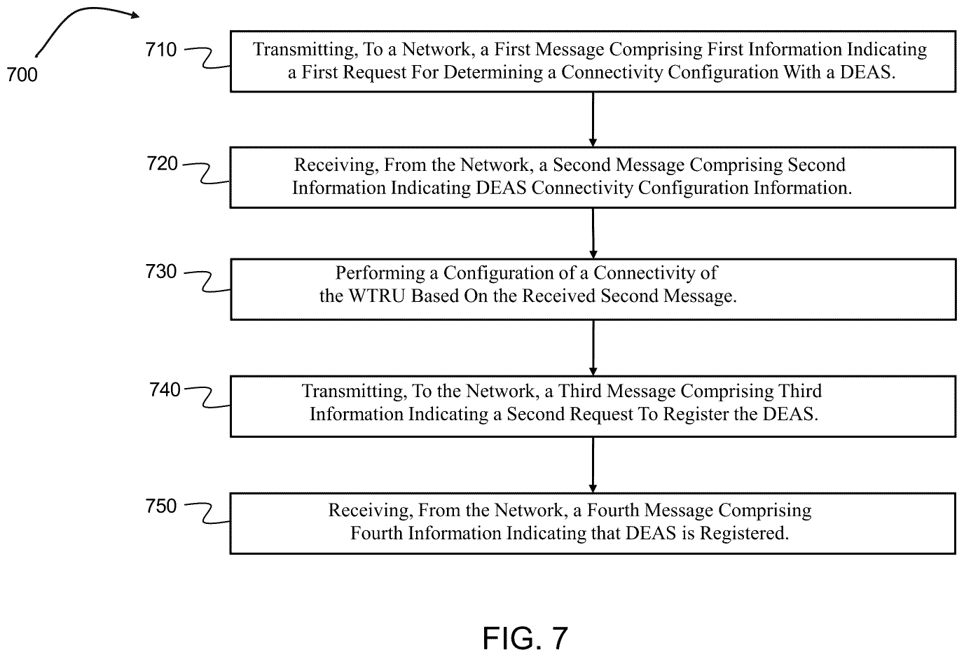

Referring to FIG. 7, a flow chart illustrating an example of a method 700, implemented in a wireless transmit/receive unit (WTRU), for a registration of a DEAS, according to an embodiment, is shown. The method 700 may comprise a step wherein the WTRU may transmit 710, to a network, a first message comprising first information indicating a first request for determining a connectivity configuration with a device edge application server (DEAS). The first information may further indicate any of: WTRU information, WTRU connectivity configuration information, and a profile of the DEAS, wherein the DEAS profile may include any of DEAS access permissions, and WTRU configuration requirements and preferences. The method 700 may comprise a step wherein the WTRU may receive 720, from the network, a second message comprising second information indicating DEAS connectivity configuration information. The DEAS connectivity configuration information may comprise a WTRU connectivity configuration information and DEAS connection information, wherein the DEAS connection information includes any of data network information, ProSe discovery filters, personal internet of things (IoT) network information, and DEAS endpoint information. The method 700 may comprise a step wherein the WTRU may perform 730 a configuration of a connectivity of the WTRU based on the received second message. The method 700 may perform a step wherein the WTRU may transmit 740, to the network, a third message comprising third information indicating a second request to register the DEAS. The third information may further indicate any of: a profile of the DEAS, and DEAS connection information based on the received second message. The method 700 may further comprise a step wherein the WTRU may receive 750, from the network, a fourth message comprising fourth information indicating that DEAS is registered. The fourth information may further indicate a registration identifier of the DEAS. In addition, the method 700 may comprise a step wherein the WTRU may forward, to the DEAS, the fourth message.

The WTRU may comprise a device edge enabler function (DEEF) providing device edge enablement services to the WTRU, and wherein performing the DEAS connectivity configuration may be triggered by the DEEF.

The method 700 may comprise a step wherein the WTRU may receive, from the DEAS, an initial request message to register the DEAS; and wherein transmitting the first message may be based on receiving the initial request message. The initial request message may comprise fifth information indicating a DEAS profile including any of DEAS access permissions, and WTRU configuration requirements and preferences. The initial request message may comprise sixth information indicating DEAS connection information including any of data network information, ProSe discovery filters, personal internet of things (IoT) network information, and DEAS endpoint information.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method, implemented in a wireless transmit/receive unit (WTRU), the method comprising:
transmitting, to a network, a first message comprising first information indicating a first request for determining a connectivity configuration with a device edge application server (DEAS);
receiving, from the network, a second message comprising second information indicating DEAS connectivity configuration information;
performing a configuration of a connectivity of the WTRU based on the received second message;
transmitting, to the network, a third message comprising third information indicating a second request to register the DEAS; and
receiving, from the network, a fourth message comprising fourth information indicating that DEAS is registered.

2. The method of claim 1, wherein the first information further indicates any of: WTRU information, WTRU connectivity configuration information, and a profile of the DEAS, wherein the DEAS profile includes any of DEAS access permissions, and WTRU configuration requirements and preferences.

3. The method of claim 1, wherein the DEAS connectivity configuration information comprises a WTRU connectivity configuration information and DEAS connection information, wherein the DEAS connection information includes any of data network information, ProSe discovery filters, personal internet of things (IoT) network information, and DEAS endpoint information.

4. The method of claim 1, wherein the WTRU comprises a device edge enabler function (DEEF) providing device edge enablement services to the WTRU, and wherein performing the DEAS connectivity configuration is triggered by the DEEF.

5. The method of claim 1, wherein the third information further indicates any of: a profile of the DEAS, and DEAS connection information based on the received second message.

6. The method of claim 1, wherein the fourth information further indicates a registration identifier of the DEAS.

7. The method of claim 1, further comprising:
receiving, from the DEAS, an initial request message to register the DEAS; and wherein transmitting the first message is based on receiving the initial request message.

8. The method of claim 7, wherein the initial request message comprises fifth information indicating a DEAS profile including any of DEAS access permissions, and WTRU configuration requirements and preferences.

9. The method of claim 7, wherein the initial request message comprises sixth information indicating DEAS connection information including any of data network information, ProSe discovery filters, personal internet of things (IoT) network information, and DEAS endpoint information.

10. The method of claim 1, further comprising:
forwarding, to the DEAS, the fourth message.

11. A wireless transmit/receive unit (WTRU) comprising a processor, a transmitter, a receiver, and a memory, and configured to:
transmit, to a network, a first message comprising first information indicating a first request for determining a connectivity configuration with a device edge application server (DEAS);
receive, from the network, a second message comprising second information indicating DEAS connectivity configuration information;
perform a configuration of a connectivity of the WTRU based on the received second message;
transmit, to the network, a third message comprising third information indicating a second request to register the DEAS; and
receive, from the network, a fourth message comprising fourth information indicating that DEAS is registered.

12. The WTRU of claim 11, wherein the first information further indicates any of: WTRU information, WTRU connectivity configuration information, and a profile of the DEAS, wherein the DEAS profile includes any of DEAS access permissions, and WTRU configuration requirements and preferences.

13. The WTRU of claim 11, wherein the DEAS connectivity configuration information comprises a WTRU connectivity configuration information and DEAS connection information, wherein the DEAS connection information includes any of data network information, ProSe discovery filters, personal internet of things (IoT) network information, and DEAS endpoint information.

14. The WTRU of claim 11, wherein the WTRU comprises a device edge enabler function (DEEF) providing device edge enablement services to the WTRU, and wherein performing the DEAS connectivity configuration is triggered by the DEEF.

15. The WTRU of claim 11, wherein the third information further indicates any of: a profile of the DEAS, and DEAS connection information based on the received second message.

16. The WTRU of claim 11, wherein the fourth information further indicates a registration identifier of the DEAS.

17. The WTRU of claim 11, configured to receive, from the DEAS, an initial request message to register the DEAS; and wherein the transmission of the first message is based on receiving the initial request message.

18. The WTRU of claim 17, wherein the initial request message comprises fifth information indicating a DEAS profile including any of DEAS access permissions, and WTRU configuration requirements and preferences.

19. The WTRU of claim 17, wherein the initial request message comprises sixth information indicating DEAS connection information including any of data network information, ProSe discovery filters, personal internet of things (IoT) network information, and DEAS endpoint information.

20. The WTRU of claim 11, configured to forward, to the DEAS, the fourth message.
